(19) United States
(12) Patent Application Publication
(10) Pub. No.: US 2013/0027840 A1
(43) Pub. Date: Jan. 31, 2013

(54) ENERGY STORAGE MODULE

(71) Applicants: Young Hak JEONG, Gyeonggi-do (KR); Hyun Chul JUNG, Gyeonggi-do (KR); Bae Kyun KIM, Gyeonggi-do (KR); Chan YOON, Seoul (KR)

(72) Inventors: Young Hak JEONG, Gyeonggi-do (KR); Hyun Chul JUNG, Gyeonggi-do (KR); Bae Kyun KIM, Gyeonggi-do (KR); Chan YOON, Seoul (KR)

(73) Assignee: Samsung Electro-Mechanics Co., Ltd.

(21) Appl. No.: 13/494,583

(22) Filed: Jun. 12, 2012

(30) Foreign Application Priority Data
Jul. 25, 2011 (KR) 10-2011-0073713

(51) Int. Cl. H01G 4/228

(52) U.S. Cl. 361/306.1

(57) ABSTRACT

Disclosed herein is an energy storage module, including: upper and lower cases each having elastic bodies provide at both side parts thereof; a capacitor cell inserted within the upper case and the lower case and having anode electrodes and cathode electrodes extended at both side parts thereof; and bus bars inserted between the anode terminals and between the cathode terminals of the capacitor cell. According to the present invention, the module can be manufactured in a comparative simple constitution, and an electric short circuit between anode and cathode terminals can be prevented when swelling occurs due to repetitive charging and discharging of capacitor cells.

### CROSS REFERENCE(S) TO RELATED APPLICATIONS

This application claims the benefit under 35 U.S.C. Section 119 of Korean Patent Application Serial No. 10-2011-0073713, entitled “Energy Storage Module” filed on Jul. 25, 2011, which is hereby incorporated by reference in its entirety into this application.

### BACKGROUND OF THE INVENTION

1. Technical Field

The present invention relates to an energy storage module, and more particularly, to an energy storage module capable of simplifying coupling of electrodes when a module is constructed using a case, by closely adhering and fixing electrodes of a capacitor cell in a compressed way when one or more capacitor cells are coupled with a case.

2. Description of the Related Art

In general, a lithium ion battery and an electrochemical capacitor, which are representative electrochemical energy storage media, are key components of a finished product requisitely used in all portable information and communication devices and electronic devices. These electrochemical energy storage media are mainly studied as high-quality energy sources of a new regeneration energy field, which is applicable to an electric car, a portable electronic device, or the like.

Here, the lithium ion battery is an energy medium enabling continuous charging and discharging by using lithium ions, and has been studied as a main power source due to a high energy density storable per unit weight or unit volume thereof. However, the lithium ion battery has much difficulty in being commercialized due to deterioration in stability, a short use period, a long charging time, and a low output density.

An electrochemical capacitor, which has recently been developed, has low energy density as compared with the lithium ion battery, but it is the fastest growing as a new alternative, substituting for the lithium ion battery due to excellent instant output and long lifetime thereof.

This capacitor has been used or developed as an energy storage module that is modularized by using a plurality of unit cells to realize high output and high capacity, and may be modularized as a subsidiary power source of a vehicle requiring a large amount of instant output, mainly such as a car. This energy storage module has a capacitor cell array structure composed of a plurality of capacitor unit cells.

A general capacitor unit cell is formed mainly in a hexahedral shape or a cylindrical shape. For modularization, additive modularizing units maybe needed in order to stack or connect in parallel one or more capacitor unit cells for fixing and electrically connect a plurality of modules.

However, in cases where the capacitor unit cells are assembled through separate fixing units or additive constituting units necessary for continuous electric connection of the capacitor unit cells, the entire structure of the energy storage module is complicated and an assembling property and a separating property of a capacitor cell array are deteriorated.

Furthermore, in cases where the capacitor unit cells are disposed only in a plane, an area occupied by the plurality of cells becomes widened, and thus, there may be a limitation in reducing the entire size of the energy storage module.

In the related art, a structure where pouch cells are continuously connected was used in a main module constitution manner, in order to absolve these problems. In the pouch cell, a plurality of collectors each having an anode terminal and a cathode terminal provided at one side or at both sides are laminated, an external part thereof is sealed with a pouch, and the anode and cathode terminals are electrically connected by ultrasonic welding.

In this pouch type module constitution, since the anode and cathode terminals are connected by the ultrasonic welding, a resistance thereof can be reduced. However, since most of the anode and cathode terminals are connected in series connected, the connection structure is complicated, and a thin plate type of pouch may be swelled, that is, may be inflated by gas generated within electrode plates of a electrode assembly body, at the time of charging and discharging the capacitor cells.

### SUMMARY OF THE INVENTION

An object of the present invention is to provide an energy storage module in which coupling between capacitor cells is closely adhered and fixed in a compressed way within a case.

According to an exemplary embodiment of the present invention, there is provided an energy storage module, including: a plurality of capacitor units each including upper and lower cases each having elastic bodies provided at both side parts thereof, and a capacitor cell inserted within the upper case and the lower case and having anode electrodes and cathode electrodes extended at both side parts thereof, wherein the plurality of capacitor units are electrically connected by bus bars inserted between the anode electrodes and between the cathode electrodes of the capacitor cells.

The upper case and the lower case each may have an inner space and the elastic bodies may be provided at locations corresponding to both side parts of the inner space. The upper and lower cases may be closely adhered to each other through a separate coupling member.

The elastic body may be configured in a plate spring type.

The elastic body may be configured such that a central portion thereof is convexly curved or angularly curved to have a triangle-shaped cross section.

The elastic bodies maybe configured such that a compressing surface is rippled to thereby maximize a contact surface.

At least one capacitor cell may be stacked within the inner spaces formed inside the upper and lower cases such that the anode terminals and the cathode terminals extended at both side parts of the capacitor cell are positoned on the elastic bodies formed at both side parts of the upper and lower cases.

The capacitor cell may be a capacitor unit cell sealed in a pouch type.

The bus bars maybe inserted between the terminals of each capacitor cell for cross connection of the anode and cathode terminals extended to both side parts of the capacitor cell to thereby achieve electrical connection between the capacitor units.

The bus bar may be configured in a ‘ [symbol] ’ letter-curved clip shape, and a hole may be formed in any one of curved surfaces of the bus bar.

### BRIEF DESCRIPTION OF THE DRAWINGS

FIG. 1 is a perspective view of a capacitor unit constituting an energy storage module according to the present invention;

FIG. 2 is a cross-sectional view of the capacitor unit constituting the energy storage module according to the present invention;

FIGS. 3 and 4 are perspective views of upper and lower cases applied to the energy storage module of the present invention;

FIG. 5 is a view showing cross sections of other examples of an elastic body applied to each of the upper and lower cases shown in FIGS. 3 and 4;

FIG. 6 is a perspective view of the energy storage module according to the present invention; and

FIG. 7 is a cross-sectional view of the energy storage module according to the present invention.

### DESCRIPTION OF THE PREFERRED EMBODIMENTS

The acting effects as well as technical configuration with respect to the objects of an energy storage module according to the present invention will be clearly understood by the following description in which exemplary embodiments of the present invention are described with reference to the accompanying drawings.

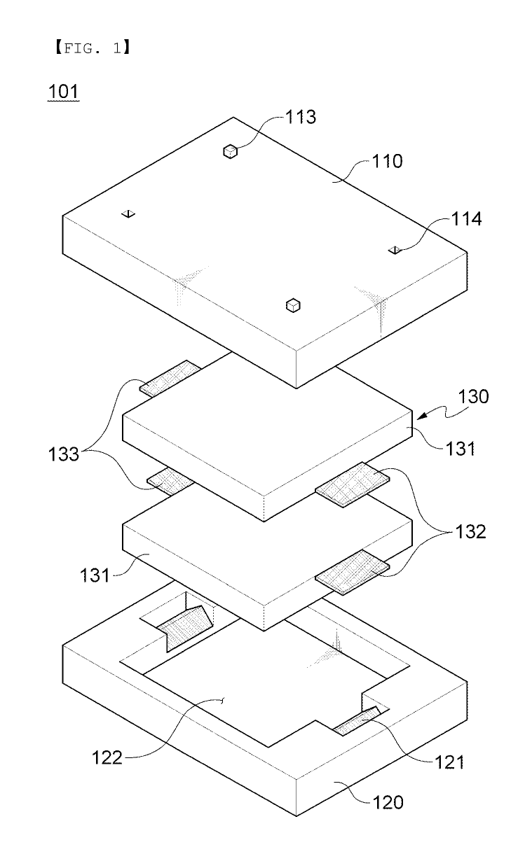

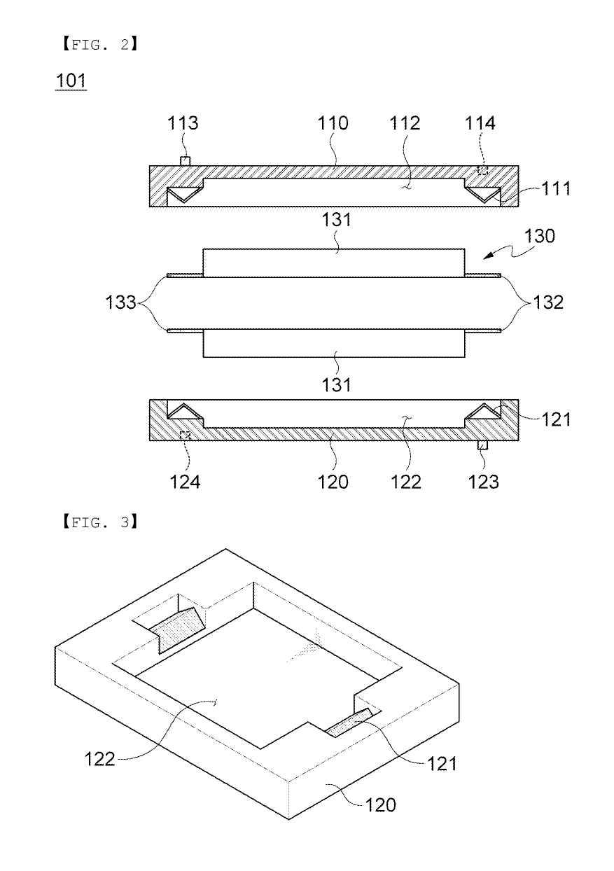

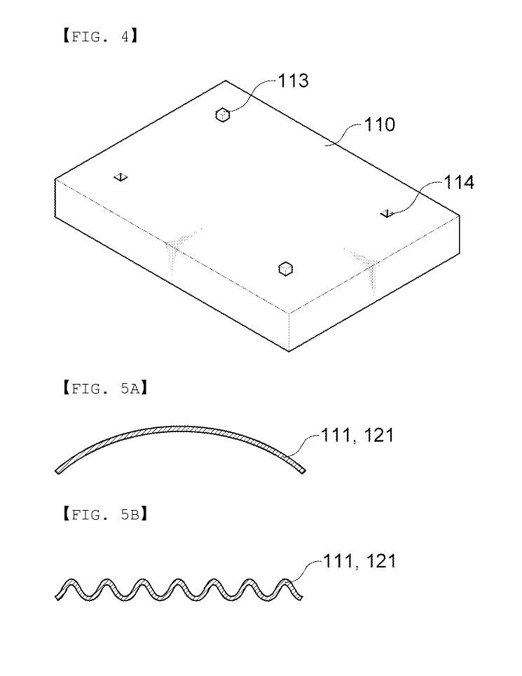

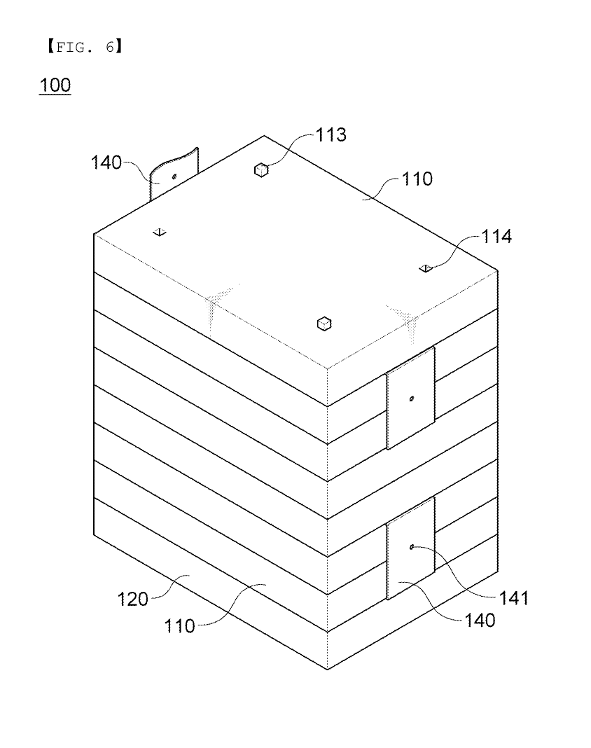

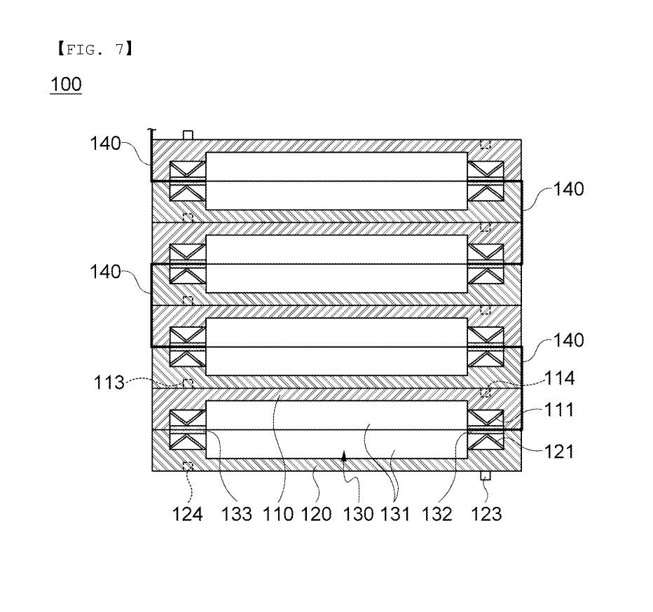

First, FIG. 1 is a perspective view of a capacitor unit constituting an energy storage module according to the present invention; FIG. 2 is a cross-sectional view of the capacitor unit constituting the energy storage module according to the present invention; FIGS. 3 and 4 are perspective views of upper and lower cases applied to the energy storage module of the present invention; FIG. 5 is a view showing cross sections of other examples of an elastic body applied to each of the upper and lower cases shown in FIGS. 3 and 4; FIG. 6 is a perspective view of the energy storage module according to the present invention; and FIG. 7 is a cross-sectional view of the energy storage module according to the present invention.

As shown in the drawings, an energy storage module 100 according to the present invention may include capacitor units 101 and bus bars 140 for electrically connecting the capacitor units 101 to each other. The capacitor unit 101 may include upper and lower cases 110 and 120 respectively having elastic bodies 111 and 121 therein, and a capacitor cell 130 inserted and fixed within the upper and lower cases 110 and 120.

The upper and lower cases 110 and 120 each may be configured in a quadrangular box of which one surface is opened. The upper and lower cases 110 and 120 have inner spaces 112 and 122 formed in the center portions thereof, within which a capacitor cell 130 is inserted. The elastic bodies 111 and 121 are installed at both side parts of the inner spaces 112 and 122, respectively.

The upper and lower cases 110 and 120 may be constituted correspondingly to each other, and thus the opened surfaces of the upper and lower cases 110 and 120 may be closely adhered to each other, and coupled with each other by a coupling member, such as bolts and nuts. Here, the elastic bodies 111 and 121 installed at the upper and lower cases 110 and 120 may be disposed at locations corresponding to each other.

In addition, the upper and lower cases 110 and 120 may be made of, mainly, a metal material, and may be configured in a box made by mixing a metal material and a resin material. Ina case of using a metal material, a metal material having excellent heat conductivity and capable of easily maintaining the strength thereof, such as aluminum, is preferable.

Meanwhile, protrusions 113 and 123 and grooves 114 and 124 may be respectively formed on the other surfaces against the opened surfaces of the upper and lower cases 110 and 120, that is to say, upper and lower surfaces of a structure in which the upper and lower cases 110 and 120 are closely adhered to each other. The protrusions 113 and 123 and the grooves 114 and 124 may be formed at corner portions correspondingly to each other so that modules 100 can be sequentially stacked while the upper and lower cases 110 and 120 are closely adhered to modularize each of the modules 100.

At least one capacitor cell 130 may be sequentially stacked and inserted within the upper and lower cases 110 and 120. Here, the capacitor cell 130 may be constituted as a pouch type unit cell, which constituted by stacking electrode assembly bodies 131 each having an anode terminal 132 and a cathode terminal 133 extended to both side parts thereof, and sealing the stacked electrode assembly bodies 131 with a pouch.

In at least one capacitor cell 130 inserted within the upper and lower cases 110 and 120, electrode assembly bodies 131 may be received in the inner spaces 112 and 122, and anode terminals 132 and cathode terminals 133 extended to both side parts of the electrode assembly bodies 131 may be positioned on the elastic bodies 111 and 121 formed at both side parts of the upper and lower cases 110 and 120.

As such, the upper and lower cases 110 and 120 are closely adhered to each other, and thus the capacitor cell 130 is closely received within the upper and lower cases 110 and 120, and the anode terminals 132 and cathode terminals 133 extended to both side parts of the capacitor cell 130 are compressed through the elastic bodies 111 and 121, and thus electric connection between electrode terminals (anode and cathode terminals) 132 and 133 can be stably made.

Meanwhile, the elastic bodies 111 and 121 formed at both side parts of the upper and lower cases 110 and 120 are installed such that they are elastically movable within the terminal connection parts formed at lateral portions of each of the inner spaces 112 and 122. The elastic bodies 111 and 121 each may be configured in a plate spring type, and thereby facilitate electrical connection and compression of the anode terminals 132 and the cathode terminals 133 positioned within the connection parts.

Here, each of the elastic bodies 111 and 121 may have a plate spring type, and a central portion thereof is protruded in an angulated shape to have a triangular cross-section, as shown in FIGS. 1 and 3, in order to improve a compressing performance above and below the anode terminals 132 and the cathode terminals 133.

In addition, in order to improve the adhering property between the anode terminals 132 and between the cathode terminals 133 of the capacitor cell 130, each of the elastic bodies 111 and 121 may be configured such that a central portion is convexly curved as shown in (a) of FIG. 5, or a compressing surface is rippled to have a plurality of concaves and convexes as shown in (b) of FIG. 5, thereby maximizing the compressing portion.

Meanwhile, the plurality of capacitor units 101, which are manufactured by inserting the capacitor cell 130 in the inner spaces 112 and 122 of the and lower cases 110 and 120 and compressing and coupling the upper and lower cases 110 and 120, may be electrically connected by bus bars 140.

The bus bars 140 serve to perform electric cross-connection of the anode terminals and the cathode terminals extended to both side parts of the capacitor cells 130. An upper curved portion and a lower curved portion of the bus bar 140 are respectively inserted between the terminals 132 and 133 of each of the capacitor cells 130 to allow electric connection between the capacitor units 101.

More specifically, electric connection between the capacitor units 101 may be achieved by inserting one of the upper curved portion and the lower curved portion of the bus bar 140 between the anode terminals 132 of the capacitor cell 130, and inserting the other of the upper curved portion and the lower curved portion of the bus bar 140 into the anode terminals 132 of another capacitor unit 101.

The bus bar 140 may be made of aluminum (Al) or copper (Cu) having excellent conductivity and lower resistance, and may be made of an aluminum alloy or a copper alloy. Also, the bus bar 140 may be made of a material having elasticity so that the bus bar 140 can be instantaneously compressed when the anode terminals 132 and the cathode terminals 133 of the capacitor cell 130 are compressed by the elastic bodies 111 and 121 of the upper and lower cases 110 and 120.

The bus bar 140 may be configured in a ‘ [symbol] ’-letter clip shape, and each of the upper curved portion and the lower curved portion thereof may be inserted between the anode terminals 132 or the cathode terminals 133 of the capacitor cell 130. Here, a hole 141 may be formed in any one of curved surfaces each consisting of a plurality of curved portions.

The reason why the hole 141 is formed in the bus bar 140 is for connection with a sensing line (not shown) for measuring a voltage applied at the time of charging the capacitor cell 130.

As set forth above, according to the energy storage module of the present invention, a plurality of capacitor units each being manufactured by inserting a plurality of capacitor cells within the upper and lower cases and compressing the anode terminals and the cathode terminals extended to both sides through elastic bodies are assembled, and then electrically connected by using bus bars, thereby manufacturing a module in a comparatively simple constitution, and thus simplifying the process.

In addition, according to the energy storage module of the present invention, the electrodes of the capacitor cells inserted in the cases are firstly connected by the bus bar and secondarily connected by springs provided at both side parts of the cases through compression, thereby preventing an electric short circuit between anode and cathode terminals when swelling occurs due to repetitive charging and discharging of capacitor cells.

While the present invention has been shown and described in connection with the embodiments, it will be apparent to those skilled in the art that modifications and variations can be made without departing from the spirit and scope of the invention as defined by the appended claims.

What is claimed is:

1. An energy storage module, comprising:
a plurality of capacitor units each including upper and lower cases each having elastic bodies provided at both side parts thereof, and a capacitor cell inserted within the upper case and the lower case and having anode electrodes and cathode electrodes extended at both side parts thereof,
wherein the plurality of capacitor units are electrically connected by bus bars inserted between the anode electrodes and between the cathode electrodes of the capacitor cells.

2. The energy storage module according to claim 1, wherein the upper case and the lower case each have an inner space and the elastic bodies are provided at locations corresponding to both side parts of the inner space.

3. The energy storage module according to claim 1, wherein the elastic body is configured in a plate spring type.

4. The energy storage module according to claim 3, wherein the elastic body is configured such that a central portion thereof is convexly curved or angularly curved to have a triangle-shaped cross-section.

5. The energy storage module according to claim 3, wherein the elastic body is configured such that a compressing surface thereof is rippled.

6. The energy storage module according to claim 1, wherein the capacitor cell is constituted of a capacitor unit cell sealed in a pouch type.

7. The energy storage module according to claim 1, wherein the bus bar is configured in a ‘ [symbol] ’ letter-curved clip shape so that each of an upper curved portion and a lower curved portion of the bus bar is inserted between the anode terminals or the cathode terminals of the capacitor cell, and wherein a hole is formed in any one of curved surfaces of the bus bar.

8. The energy storage module according to claim 1, wherein protrusions and grooves are symmetrically formed at corner parts corresponding to each other, on the other surfaces against the opened surfaces of the upper and lower cases.
